(19) United States
(12) Patent Application Publication
(10) Pub. No.: US 2001/0027688 A1
(43) Pub. Date: Oct. 11, 2001

(54) System for monitoring the behavior and environmental condition of a high precision electronic apparatus

(76) Inventor: Hideyuki Yamanaka, Tokyo (JP)

Correspondence Address: DOUGHERTY & TROXELL, SUITE 1404, 5205 LEESBURG PIKE, FALLS CHURCH, VA, 22041, US

(21) Appl. No.: 09/822,417

(22) Filed: Apr. 2, 2001

(30) Foreign Application Priority Data
Apr. 11, 2000 (JP) H12-147,102

(51) Int. Cl. G01N 17/00

(52) U.S. Cl. 73/865.6; 73/571

(57) ABSTRACT

A system for monitoring the behavior and environmental conditions of a high precision electronic apparatus comprising a measuring device section (M) including a plurality of sensors (12, 13, 14, 15, 16 and 17) arranged around said high precision electronic apparatus (P) which is mounted on a vibration preventing mount (B) for detecting environmental conditions as analog data signals, and means for filtering and amplifying each of said analog data signals (20,21 and 22), and a computer system section (C) connected with said measuring device section (M) having an A/D convertor (32) for converting said analog data signals into ditigital data signals, a data collection circuit (34) for collecting said digital data, means (38)for recording and setting prescribed allowable environmental condition data, means (39) for comparing said allowable environmental condition data with said digital data, means (40) for producing warning signal if abnormalities between said allowable environmental condition data and said digital data obtained in operation of said apparatus, a Fast Fourier Transform (FFT) analyzer (41) for converting said digital data so as to display as a graph on a monitor (37), a read-only memory (42) for storing said digital data, means (43) for calculating fluctuation of said magnetic flux data, means (44) for calculating fluctuation of said vibration data, and means (45) for storing said fluctuation of said magnetic flux and vibration data as temporal data.

### FIELD OF THE INVENTION

This invention relates to a system for monitoring the behavior and environmental condition of a high precision electronic apparatus, and more particularly to a system for monitoring the operation and environmental condition of a high precision electronic apparatus to be used for manufacturing or assembling semiconductor devices, liquid crystal displays, electronic components and the like.

### BACKGROUND OF THE INVENTION

In manufacturing or assembling electronic devices such as integrated circuit boards, semiconductor devices, liquid crystal devices and the like, it is generally required to utilize ultra-precision technology, and therefore the environmental conditions and behavior or operation of the high precision electronic apparatus (hereinafter it is referred to as a “main electronic apparatus”) for manufacturing and assembling the circuit boards and others must be carefully considered.

For example, the vibration of the main electronic apparatus during the operation, and fluctuation of temperature, magnetic field, cleanness of air, noise in the environment surrounding the main electronic apparatus will affect to the operation thereof.

The main apparatus installed in a clean room of the factory will be significantly affected by the operation of a large number of apparatuses or machines. For example, loud noise and large external vibration will be caused by an air conditioning system.

The allowable data relating to vibration, temperature, magnetic field, sound or noise and wind speed in the environment of the main electronic apparatus are usually given from the makers of the main electronic apparatus. On the other hand, fluctuations in the magnetic field which effects upon the main electronic apparatus will be caused from DC wires or cables which are distributed or surrounded the factory in which the main electronic apparatus is installed, and also it is very hard to disregard fluctuations in the magnetic field owing to the operation of elevators in the factory.

In order to protect the main electronic apparatus from the foregoing vibration and fluctuations in the magnetic field, the main electronic apparatus are usually installed on an expensive vibration proof mount and surrounded by walls which isolate the magnetic field. However, the chief disadvantage of the above is very expensive, and tere is a limit in ability of the above vibration proof mount and walls.

In view of the above, it is a main object of the present invention to provide a system for monitoring the behavior and environmental condition of the high precision electronic apparatus in order to avoid or minimize the effect of external vibration, magnetic field, noise and others.

It is a further object of this invention to provide a system for monitoring the behavior and environmental condition of the high precision electronic apparatus by recording the change of the environmental conditions as measured data at real-time.

It is another object of the invention to provide a system for monitoring the behavior and environmental condition of the high precision electronic apparatus by recording or storing the allowable operation data in the computer system, and comparing the allowable operation data with the measured data obtained from the main electronic apparatus in usual operation in order to display the results of the comparison.

In order to attain these objects, the system for monitoring the behavior and environmental condition of the main electronic apparatus according to the present invention comprisding a measuring device section including a plurality of sensors and a microphone arranged around said electronic apparatus which is mounted on a vibration preventing mount for detecting environmental conditions as analog data signals, and means for filtering and amplifying each of said analog data signals, and a computer system section connected with said measuring device section having an A/D convertor for converting said analog data signals into ditigital data signals, a data collection circuit for collecting said digital data, means for recording and setting prescribed allowable environmental condition data, means for comparing said allowable environmental condition data with said digital data, means for producing warning signal if abnormalities between said allowable environmental condition data and said digital data obtained in operation of said apparatus, a Fast Fourier Transform (FFT) analyzer for converting said digital data so as to display as a graph on a monitor, a read-only memory for storing said digital data, means for calculating fluctuation of said magnetic flux data, means for calculating fluctuation of said vibration data, and means for storing said fluctuation of said magnetic flux and vibration data.

### BRIEF DESCRIPTION OF THE DRAWINGS

The foregoing features of this invention, as well as the invention itself, may be more fully understood from the following detailed description read together with the accompanying drawings, in which:

FIG. 1A is a schematic block diagram showing a measuring device section of a system for monitoring the behavior and environmental condition of the precision electronic apparatus according to the present invention; and

FIG. 1B is a schematic block diagram showing a computer system section of a system for monitoring the behavior and environmental condition of the high precision electronic apparatus according to the present invention.

### DETAILED DESCRIPTION

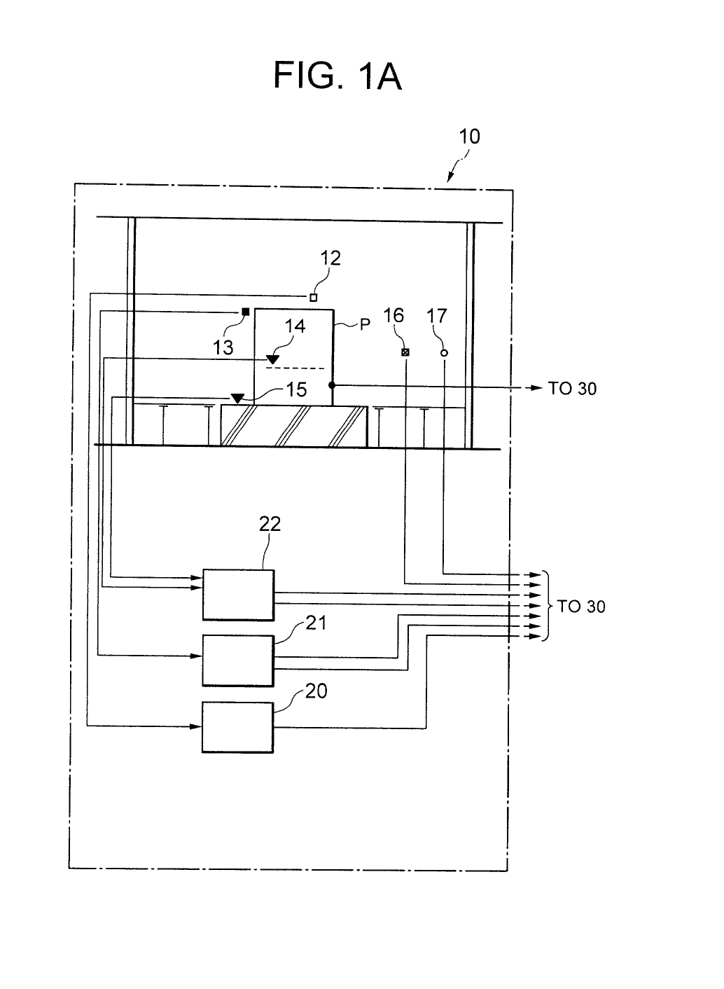

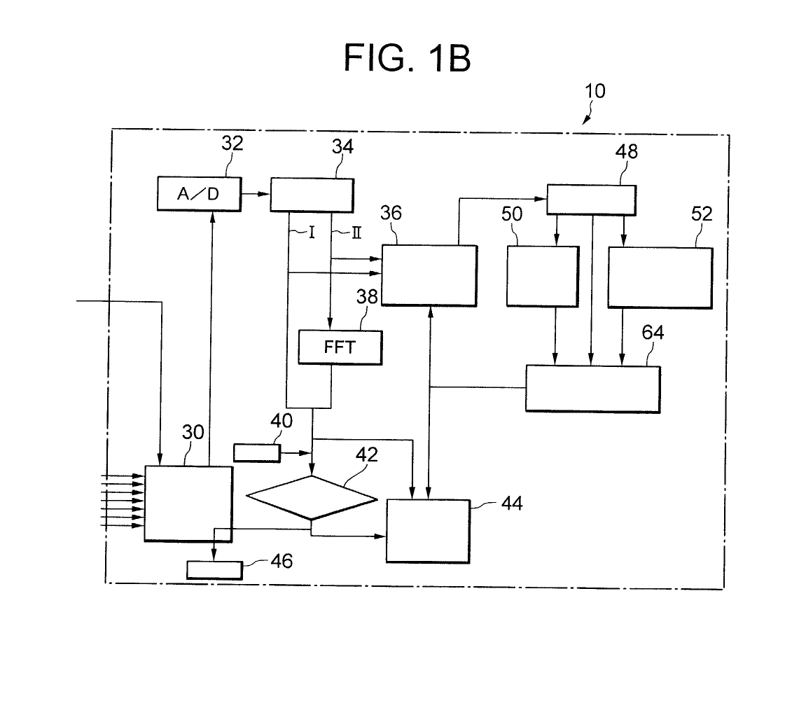

Referring now to the drawings, as shown FIG. 1A and FIG. 1B, a system 10 for monitoring the behavior and environmental condition of the high precision electronic apparatus (main electronic apparatus) P according to the present invention includes a measuring device section M and a computer system section C for treating measured analog data obtained by the measuring device section M.

The measuring device section M includes a microphone 12 for receiving the sound and noise which are generated by the operation of the main apparatus P, a flux sensor 13 for detecting the magnetic field in the environment of the main electronic apparatus P, a first vibration sensor 14 for detecting the vibration of the main electronic apparatus P, a second vibration sensor 15 for detecting the vibration of a mount B of the main electronic apparatus P, a temperature sensor 16 for detecting the temperature in the environment of the main electronic apparatus P, and a wind sensor 17 for measuring the wind speed in the neighborhood of the main electronic apparatus P.

The sound received in the microphone is transmitted to a sound level meter 20 as analog data signal and is amplifyed and compensated with respect to the characteristics of A/C/F, and the flux detected by the flux sensor 13 is filtered and divided into DC component and AC component.

The amplitude of each of fluctuations of analog data signals received by the sound level meter 20 flux meter 21 and vibration meter 22 is converted into a definite amplitude of a given duration, and transmitted to a terminal 30 of the computer system section C together with the output trigger signals from the main electronic apparatus P which show the behavior thereof.

These analog signals entered into the computer system section C are converted into digital signals by an A/D converter 32 and transmitted to a data accumulator 34 by which the data signals of flux, temperature and wind speed are summarized as a first real-time data I and the data signals of vibration and sound or noise are summarized as a second real-time data II.

These first and second real-time data signals I, II are respectively stored in a hard desk 36 as the temporal data which may be displayed on a hardware monitor 37, if necessary.

The first and second real-time data signals I,II are compared with allowable operation data by a comparator 38. And a result of the comparison of the real-time data with allowable data is interpreted in an interpreter 39 and displayed on the monitor 37. If the result of the comparison is within 80% of the allowable data, an indicator 40 shows it in blue light, but if not, the light will turn to red.

The latest first and second real-time data I, II are respectively stored in a read-only memory 41, the magnetic field data in the first and second real-time data I, II are transferred to a calculator 42 to inspect variation thereof, the data of the temperature and wind speed which are stored in the ready-only memory 41 are sent to a temporal data renewal device 43, and the vibration and noise data are processed by a Fast Fourier Transform (FFT) analyzer 44, and then these data are sent to the temporal data renewal circuit 43 so as to update them.

As stated in the above, the latest data which are measured with respect to the behavior and environment conditions of the main apparatus P may be renewed.

What is claimed is:

1. A system for monitoring the behavior and environmental condition of a high precision electronic apparatus comprising:
a measuring device section including a plurality of sensors, a microphone and wind gage arranged around said electronic apparatus which is mounted on a vibration preventing mount for detecting environmental condition as analog data signals, and means for filtering and amplifying each of said analog data signals, and
a computer system section connected with said measuring device section having an A/D convertor for converting said analog data signals into ditigital data signals, a data collection circuit for collecting said digital data, means for recording and setting prescribed allowable environmental condition data, means for comparing said allowable environmental condition data with said digital data, means for producing warning signal if abnormalities between said allowable environmental condition data and said digital data obtained in operation of said apparatus, a Fast Fourier Transform (FFT) analyzer for converting said digital data so as to display as a graph on a monitor, a read-only memory for storing said digital data, means for calculating fluctuation of said magnetic flux data, means for calculating fluctuation of said vibration data, and means for storing said fluctuation of said magnetic flux and vibration data.

2. A system as claimed in claim 1 in which said sensors include a flux sensor for detecting the magnetic field in the environment of said apparatus, a first vibration sensor for detecting the vibration of said apparatus, a second vibration sensor for detecting the vibration of a mount of said apparatus and a temperature sensor for detecting the temperature in said environment.

3. A method for monitoring the behavior and environmental condition of a high precision electronic apparatus including steps for:
detecting the magnetic field, noise, temperature and wind speed in the environment of said apparatus as analog data,
detecting the vibration according to the operation of said apparatus and the vibration of a mount of said apparatus as analog data,
filtering and amplifying said analog data,
converting each of said analog data into digital data,
collecting said digital data signals,
recording setting allowable data of the operation of said apparatus in normal condition,
comparing said allowable data with said digital data,
displaying the comparative result of said allowable data with said digital dataon a monitor, and
giving warning if the result of comparison is abnormal.
